(19) United States
(12) Patent Application Publication
(10) Pub. No.: US 2017/0300993 A1
(43) Pub. Date: Oct. 19, 2017

(54) PRICE SEARCHING METHOD AND SYSTEM

(71) Applicant: PRICEPER, LLC, La Jolla, CA (US)

(72) Inventors: Yan Alexander Shainsky, Escondido, CA (US); Arthur Braunstein, San Diego, CA (US)

(73) Assignee: PRICEPER, LLC, La Jolla, CA (US)

(21) Appl. No.: 15/487,337

(22) Filed: Apr. 13, 2017

Related U.S. Application Data
(60) Provisional application No. 62/322,180, filed on Apr. 13, 2016.

(51) Int. Cl. G06Q 30/06

(52) U.S. Cl. CPC G06Q 30/0629

(57) ABSTRACT

A non-transitory, computer-readable product for providing analytics, comprising code executable by one or more processors for causing the one or more processors to receive, from a first client, a data set relating to an object; correlate the data set to the object; cause the storage of the data set within memory; enrich pre-existing static data with the data set; receive, from a second client, a query that indicates an analytic function to be performed on the static data; and in response to receipt of the query that indicates the analytic function to be performed on the static data cause the loading of memory, from a first source, with data stored as the static data; cause real-time data to be received, as it is being generated by a second source, and to cause the return, to the second client, a result relating to the query.

### CROSS-REFERENCE TO RELATED APPLICATION(S)

The present application claims priority to U.S. Provisional Patent Application No. 62/322,180 filed on Apr. 13, 2016, entitled “PRICE SEARCHING METHOD AND SYSTEM” the entire disclosure of which is incorporated by reference herein.

### BACKGROUND OF THE INVENTION

### 1. Field of the Invention

The present invention relates to the field of obtaining pricing for goods and services in a local or wider area so that a user can make an informed decision based on whether they should purchase a product or service.

### 2. Description of Related Art

There exists in the art price searching and quote generating tools and resources whereby a user can manually search and request a price for a desired good or service. These systems may draw information from service providers or customers without any or minimal analysis of the data provided. Often when a user undertakes a task of price searching, he or she is presented with non-specific data, data that has not been analyzed, and is presented in a manner that is not useful to the user. This is makes it difficult for a user to ascertain the true cost of a service relative to geographic and other parameters, all from one source.

Based on the foregoing, there is a need in the art for a means of gathering, analyzing, and displaying price data to a user in a meaningful way such that a user can make an informed decision about the price of a service. There also remains a need for the user to be able to be informed about how the price is being generated so that the user is able to identify with a particular pool of data that is presented in a user-friendly way.

### SUMMARY OF THE INVENTION

In one embodiment, the present disclosure comprises a non-transitory, computer-readable product for providing analytics, comprising code executable by one or more processors for causing the one or more processors to receive, from a first client, a data set relating to an object; correlate the data set to the object; cause the storage of the data set within memory; enrich pre-existing static data with the data set; receive, from a second client, a query that indicates an analytic function to be performed on the static data; and in response to receipt of the query that indicates the analytic function to be performed on the static data cause the loading of memory, from a first source, with data stored as the static data; cause real-time data to be received, as it is being generated by a second source, and to cause the return, to the second client, a result relating to the query.

In another embodiment of the present disclosure, the result comprises averages, modes, medians, means, variances, or standard deviations.

In another embodiment of the present disclosure, the object comprises goods or services purchased by the first client; or goods or services offered by sellers.

In another embodiment of the present disclosure, the one or more processors are further configured to receive a request relating to the data set; and return the data set relating to the request.

In another embodiment of the present disclosure, the one or more processers are further configured to cause the storage of the result of the analytic function in storage media as an analytic cube for use in subsequent queries together with a time stamp in association with the result of the analytic function, as part of the analytic cube; and in response to a subsequent analytic function that includes the time stamp, re-use the result of the analytic function from storage media based on the time stamp associated therewith, as a source of data for the subsequent analytic function.

In another embodiment of the present disclosure, the first source is external to the processor.

In another embodiment of the present disclosure, the second source is external to the processor.

In another exemplary embodiment of the present disclosure, the invention comprises a method for providing analytics comprising receiving and storing a user profile; sending the user profile to one or more databases over one or more wired or wireless networks; receiving input from a user relating to an object, the object being a good or a service; sending the input from the user to the one or more databases to be used to enrich the object; receiving a request for analytics from the user; sending the request to the one or more databases; receiving a response to the request from the one or more databases; and displaying the response to the user.

In another embodiment of the present disclosure, the object comprises a good or a service purchased by the user or a good or a service offered to the user.

In another embodiment of the present disclosure, the response comprises averages, modes, medians, means, variances, or standard deviations.

In another embodiment of the present disclosure, the response comprises an aggregate of data from sources other than the user; and a particular data set specified by the user.

In another exemplary embodiment of the present disclosure, the invention comprises a system for providing analytics comprising one or more storage devices; and a plurality of processors, the plurality of processors being configured to receive, from a first client, a data set relating to an object; correlate the data set to the object; store the data set within the one or more storage devices; enrich pre-existing static data with the data set; receive, from a second client, a query that indicates an analytic function to be performed on the static data; and in response to receipt of the query that indicates the analytic function to be performed on the static data, cause the loading of the data stored on the one or more storage devices as the static data; receipt of real-time data by the processor as it is being generated by a second source; and return of a result, relating to the query, to the second client.

In another embodiment of the present disclosure, the plurality of processors is operable in conjunction with a non-transitory, computer-readable product comprising code executable by a processor.

In another embodiment of the present disclosure, the result comprises averages, modes, medians, means, variances, or standard deviations.

In another embodiment of the present disclosure, the object comprises goods or services purchased by the first client; or goods or services offered by sellers.

In another embodiment of the present disclosure, the plurality of processors is further configured to receive a request relating to the data set; and return the data set relating to the request.

In another embodiment of the present disclosure, the plurality of processers is further configured to cause the storage of the result of the analytic function in storage media as an analytic cube for use in subsequent queries together with a time stamp in association with the result of the analytic function, as part of the analytic cube; and in response to a subsequent analytic function that includes the time stamp, re-use the result of the analytic function from storage media based on the time stamp associated therewith, as a source of data for the subsequent analytic function.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exemplary flow chart diagram, according to an embodiment of the present invention.

FIG. 2 is a homepage view of the app, according to an embodiment of the present invention.

FIG. 3 is a service price graph view of the app, according to an embodiment of the present invention.

FIG. 4 is a service price graph view of the app, according to an embodiment of the present invention.

FIG. 5 is a flowchart, according to an embodiment of the present invention.

FIG. 6 is a service averages cart view of the app, according to an embodiment of the present invention.

FIG. 7 is a detailed service view of the app, according to an embodiment of the present invention.

FIG. 8 is a service submit view of the app, according to an embodiment of the present invention.

FIG. 9 is a category request page of the app, according to an embodiment of the present invention.

FIG. 10 is the business user page of the app, according to an embodiment of the present invention.

FIG. 11 is the converter page of the app, according to an embodiment of the present invention.

### DETAILED DESCRIPTION OF PREFERRED EMBODIMENTS

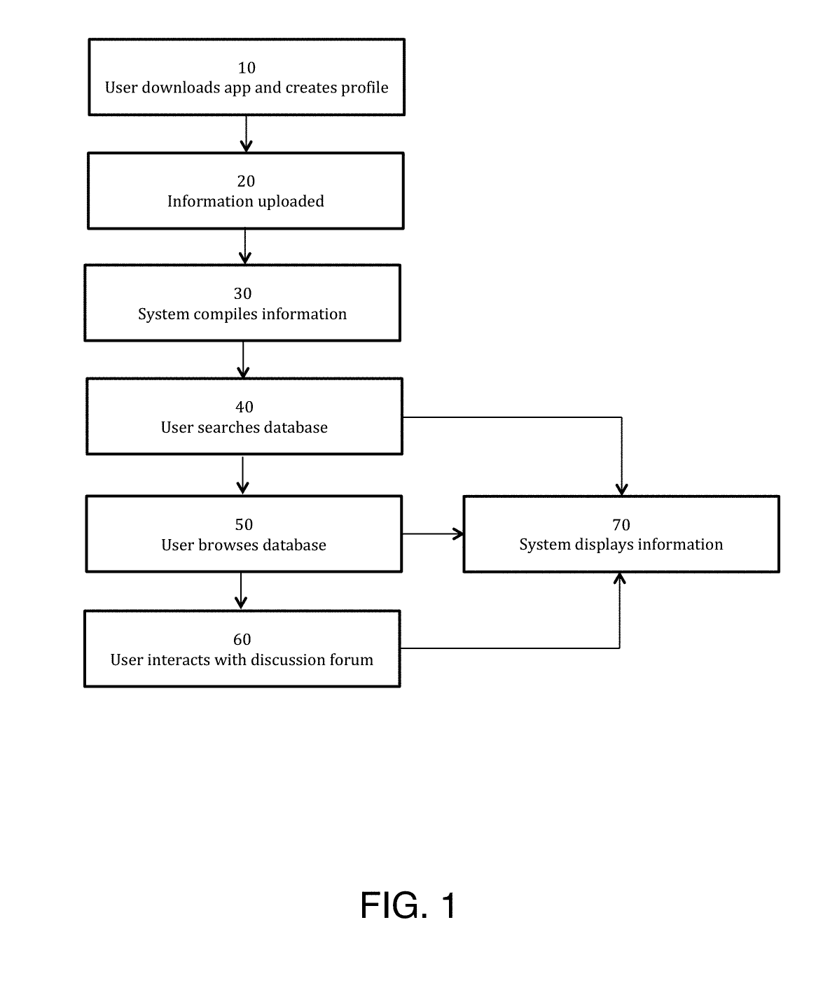

Preferred embodiments of the present invention and their advantages may be understood by referring to FIGS. 1-11.

In an exemplary embodiment of the present disclosure, there are multiple different types of users. In an exemplary embodiment, there are users who are administrators (“ADMIN”) and have full privileges of the site and can control the functionality and operation of the method and system. In another exemplary embodiment, there are users who are moderators (“MOD”) and have partial privileges and control of the functionality and operation of the method and system similar to an administrator with limited control. In another exemplary embodiment, there are users who are authenticated basic users (“User”) and are visitors who have created an account in the system. In another exemplary embodiment, there are users who are authenticated paid users (“Paid user”) and are visitors who have paid for additional features that give them special access to certain data and graphs that other users cannot see. In another exemplary embodiment, there are users who are authenticated paid service providers (“Paid owner”) and are service providers that can submit new prices, monitor click-through, etc. In another exemplary embodiment, there are users who are unauthenticated users (“visitors”) who are able to visit the site and have limited ability to view and contribute to the data in the database and system.

In another exemplary embodiment of the present disclosure and with reference to FIG. 1, in step 10, the system uses a mobile device and a program loaded thereon, known as an app. The mobile device comprises any device that uses wired or wireless data transmission technology including mobile phones, laptop computers, desktop computers, tablets, internet of things (“I.o.T”) devices, appliances, and automotive vehicles or their components. The system uses the app to communicate information from the user's mobile device to a database. The database comprises one or more computer computation and storage mediums. In one embodiment, the database comprises a cloud-based data storage and computation service. In another embodiment, the database communicates with the mobile device over one or more wired or wireless networks. The app gathers the device information including device-identifying information such as the device's serial number, the device's model number, and geo-positional locating information such as global positioning satellite (“GPS”) coordinates from the mobile device's hardware and software. The app also gathers information manually entered by the user including a username and password. A user creates a user profile using the app or other device. The system uses the user profile to identify a mobile device and associate it with the user. In another embodiment of the present disclosure, the system utilizes a subscription-based service to correlate the user and the user's specific devices based on device information including the manufacturer, device model number, device serial number, and other identifying information. In another embodiment, the user creates a user profile that the system uploads and stores on the database. The user profile may comprise the user's preferences comprising specific areas of interest, specific types of goods or services for which the user desires to receive additional information, and the like.

In another exemplary embodiment of the present disclosure and with reference to FIG. 1, in step 20, the user uploads information relating to goods or services purchased by the user. This information comprises a description of the goods or services, the price paid for the goods or services, and the user's feedback regarding the goods or services. In another embodiment, the system uploads and stores this information on the database. In another embodiment, information relating to goods or services is uploaded to the system by source other than users. For example, a retailer of a good or service may upload information relating to goods or services offered. In another embodiment, the user need not have a registered account to upload information to the system.

In another exemplary embodiment of the present disclosure and with reference to FIG. 1, in step 30, the system complies information uploaded by users. In one embodiment, the system receives and stores data from users. The system takes the data as arguments and compiles various metrics. In another embodiment, the metrics may include the average, mode, median, mean, variance, or standard deviation. The system stores these metrics and may make them available for other users to view. In another embodiment, the system updates relevant data to particular metrics and recalculates the metrics on a predetermined interval. In another embodiment, the system updates relevant data to particular metrics and recalculates the metrics each time a user updates the data. In another embodiment, the system calculates and generates a graphical representation of the metrics. In one embodiment, the graphical representation comprises a bell curve. In another embodiment, the system generates and stores the graphical representation on a predetermined interval. In another embodiment, the system generates and stores the graphical representation each time a user updates pertinent data.

In another exemplary embodiment of the present disclosure and with reference to FIG. 1, in step 40, as user may search the database. In one embodiment, the user enters desired search parameters using the mobile device. The system receives the user's input through the mobile device and communicates that information to the database. The system returns data corresponding the user's search parameters to the mobile device. The system displays the requested information to the user on the mobile device. In another embodiment, the user's desired search parameters may be entered into the system using one or more keywords. In another embodiment, the user's desired search parameters may be entered using Boolean search operators. In another embodiment, the user may narrow keyword searches using menus comprising category. In another embodiment, a user may request a new category if a desired category is not already pre-defined. In another embodiment, the system narrows the user's desired search parameters based on the user's profile settings.

In another exemplary embodiment of the present disclosure and with reference to FIG. 1, in step 50, the user may browse the database. In one embodiment, the user may select from a predetermined list of categories. In one embodiment, if a particular desired category is not predefined, the user may send a request to the system to create that category that is created in the app and delivered to the database. In another embodiment, the user may browse the database by a selectable aspect. The aspect comprises username, category, sorting, featured articles, special deals, coupons, and suggest services. In one embodiment, the system configures the selectable aspect based on the user's profile. In another embodiment, the system configures the aspect by the user's selection history.

In another exemplary embodiment of the present disclosure and with reference to FIG. 1, in step 60, the user may interact with a discussion forum. In one embodiment, the system provides a discussion forum within which users may interact with one another regarding particular products or services. In one embodiment, the system generates a discussion forum for each product or service inputted by a user. In another embodiment, the users may create a discussion forum. In another embodiment, the system provides one or more predetermined discussion for a to the users. In another embodiment, the system uses the app to display a graphical representation of the discussion forum. The system uses the mobile device to allow the user to interact with the discussion forum. In another embodiment, the discussion forum is stored on the database.

In another exemplary embodiment of the present disclosure and with reference to FIG. 1, in step 70, the system displays information to the user on the mobile device. In one embodiment, the system delivers information to the mobile device using one or more wired or wireless networks. The system displays the information through the app and using the mobile device's built in screen. In another embodiment, the system uses the mobile device's built in input abilities to allow the user to interact with the system though the app. In another embodiment, the user may use the mobile device's built-in touch screen to interact with the app. In another embodiment, the user may specify particular ranges of data to display. In one embodiment, the user may select specific data ranges within which relevant data was collected by the system. In another embodiment, the user may select specific price ranges paid by other user to display. In another embodiment, the system displays the information such that it readily indicates the source of the information. For example, the system comprises a specific icon that displays information uploaded by a seller of a good or service.

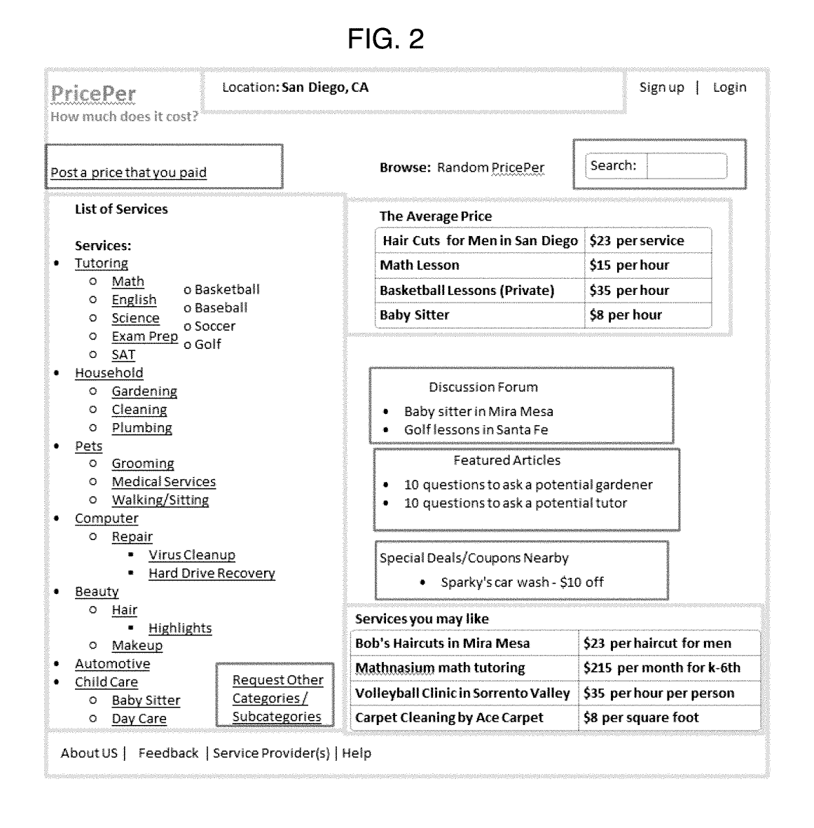

In another exemplary embodiment of the present disclosure and with reference to FIG. 2, a user is downloading the application and is viewing a home or main page that serves as the main landing page for the domain. In an embodiment, visitors and users have multiple features and interactions with the page. In an embodiment, there is a link to the Sign-up/Login area where a user can sign up and register as a user, paid user and paid owner or where a user can login if they are already registered. In an embodiment, the home page has a select location field where a default city can be set, for example San Diego, Calif. and San Diego will be defined as the County of San Diego, and will encompass any submissions made by a visitor or user within a specified list of zip codes that is extracted from a database that is connected to and communicates with the system. In an embodiment, administrators are able to add additional cities to the list in the database with relative ease, and select the initial list of categories to be used for the city.

In another exemplary embodiment of the present disclosure, and with reference to FIG. 2, a user is able to input terms into a search field to search for prices of goods and services of a particular category located on a database. In an embodiment, a user is posting information about the price that they paid for a service, goods or combination. The information entered by the user is recorded and uploaded into the database. In an embodiment, the database contains data inputted by the user and other users, reflecting the prices they actually paid for goods and services, in a category and specific geographical location. In an embodiment, offers for services are inputted by paid owner users, and are not used in calculating average prices. In an embodiment, a user is inputting feedback and indicating a satisfaction rating about services that they received. In an embodiment, the data in the database is collected from sources other than the users, such as but not limited to external databases on the Internet and other private databases such as from that of businesses. In an embodiment, the prices in the database are obtained from automated data scraping programs and manual uploading or inputs from multiple users.

In an embodiment, the database contains information about multiple service price points, service price points for different categories of services, service price points for different quality of services, service price points from for services posted by a particular subset of users that is categorized by the system, user reviews, as well as information about the authenticated users, and their individual preferences. For example, a user may set a preference to only display data points from authenticated users and not from paid vendors. In an embodiment, depending on the type of user, as determined at registration or some other measure, the information entered is categorized, analyzed and displayed in a representative format that other users can view. Data entered from a multiple number of users and other databases in collected and categorized into types of services for example hair cuts for men in San Diego, Math Lesson in Del Mar, Basketball Lessons (Private), Baby sitter (experienced). The system analyzes and calculates average prices based on the user entries and other collected data, type of user, time of year and season, known economic factors and other predetermined variables to produce an average price paid for a particular defined service.

In another embodiment of the present disclosure and with reference to FIG. 2, a user is viewing a List of Services that is a listing of top-level services for which previous users have posted prices that they paid for a particular service in a category appearing in the list. An administrator specifies which top-level categories are listed on the home page randomly and/or based on various parameters, such as for example popularity, trends or specific categories identified on the user's registration information. Each category or item in the list of services is linked to the Average Price Page for the category that appears so that a user can click into the average price paid page through the categories in the list of services on the home page. In an embodiment, the list of services is alphabetically arranged. In an embodiment, there are multiple sub-levels of categories listed on the homepage. If a user is searching for a service category that doesn't exist and/or would like to add a new category or sub category, a user clicks into the Category Request link and proceeds to request a new category for a price that they paid. In an embodiment, only authenticated users are able to request a new category and/or sub-category.

In another embodiment of the present disclosure and with reference to FIG. 2, a user is viewing The Average Price list of selected average prices that were paid for particular services and categories, for example hair cuts for men in San Diego $23 per service, Math Lesson in Del Mar $15 per hour, Basketball Lessons (Private) $35 per hour, Baby sitter $8 per hour. In an embodiment, the selected average prices listed on The Average Price list are randomly pulled up through available average prices in the database. In other embodiments, The Average Price list is generated based on parameters of interest as indicated by the user in an internal system profile generated at registration, by linking to an external profile such as a social media site, as detected by the system based on browsing and clicking history or some other predetermined algorithm. The user can see one or more services that show a general category and the average price paid for that particular category, for example. In an embodiment, each item displayed is linked to a page that displays a list of the actual prices paid from which the average is generated.

In another embodiment of the present disclosure and with reference to FIG. 2, a user is participating in Discussion Forums. For example, on the home page a user can view a list of the last few most active and recent discussion forum topics relating to a specific service or category in San Diego (or the city for which the user is browsing). The topics listed under the Discussion Forums heading, are linked to the specific discussion forum page that is related to that particular topic or service category. The Discussion Forums heading is linked to a list of all the Discussion Forums that are all regularly refreshed.

In another embodiment of the present disclosure and with reference to FIG. 2, the home page has Featured Articles. The Featured Articles can be linked to randomly selected featured articles, articles that relate to the discussion forums, articles that relate to a user's identified interests. For example a maximum of four articles are displayed on the home page. In an embodiment, a user who is an administrator is able to over-write, and re/select the articles. The list of Featured Articles refreshes on a predetermined interval, for example every 24 hours.

In another embodiment of the present disclosure and with reference to FIG. 2, on the home page, a user is viewing a list of Special Deals and Coupons Nearby. This feature allows service providers and business to post specials about their services for example, Sparky's car wash—$10 off. In an embodiment, the business providers pay a fee for posting special deals that appear on the home page. In other embodiment's, users are able to input specials that they received and are aware exist.

In another embodiment of the present disclosure and with reference to FIG. 2, the user is viewing a list of Suggested Services by the system based on parameters of interest as indicated by the user in an internal system profile generated at registration, by linking to an external profile such as a social media site, as detected by the system based on browsing and clicking history or some other predetermined algorithm. In an embodiment, the business providers pay a fee for posting Suggested Services that appear on the home page. In other embodiment's, users are able to suggest services to other users that they are linked to in the system or on other external systems.

In an embodiment, the app is displaying a page footer that has links to other pages including About Us, Feedback, Blog, Service Providers and Help pages. In an embodiment, there is a Display Mission Statement that appears on the app, for example possible Mission Statements may be: PricePer is the easy way to connect with local service providers; PricePer is the perfect place to find local service providers at the right price; Use PricePer to get a fair price at your local service providers.

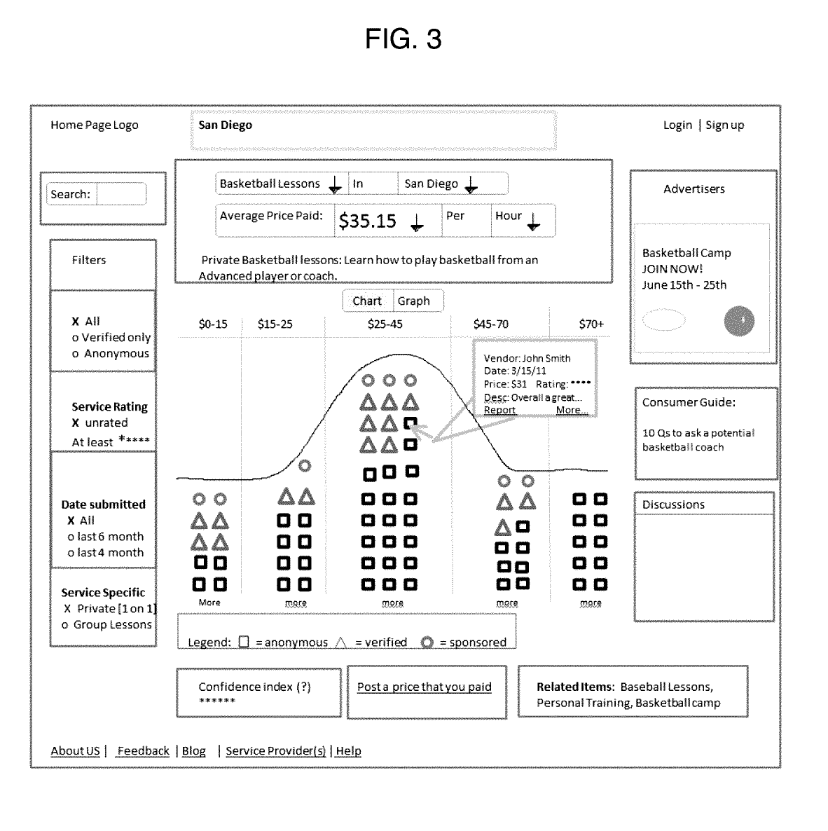

In another embodiment of the present disclosure and with reference to FIG. 3, a user is presented with a graphical display of prices paid for a particular service category called the Service Price Graph. In an embodiment, the service price graph page serves as the main layout and display for app and website, such that when a user clicks on a listed service, they are directed to and presented with the Service Price Graph page. The system is querying data from the database, and the data and data elements are sorted based on their common deviation from the mean, and the graph is built out dynamically. The overall “average” price per service paid and category of service is derived from the whole data stored on the database and/or located on an external system, and presented in the graph.

In another embodiment of the present disclosure, the system features an algorithm for generating, analyzing, showing and displaying the unique icons that are produced from the system's unique algorithm and data points, under a bar chart and/or bell curve, in linear columns that represent individual prices paid for services. Common (or top-level) categories can be cached. When hovering over an individual icon, additional pop-up appears with additional info. Filtering is available that is based on the category selected. For example, the “Lessons” category should have a service-specific filter of whether the service was done in private or as a group lesson.

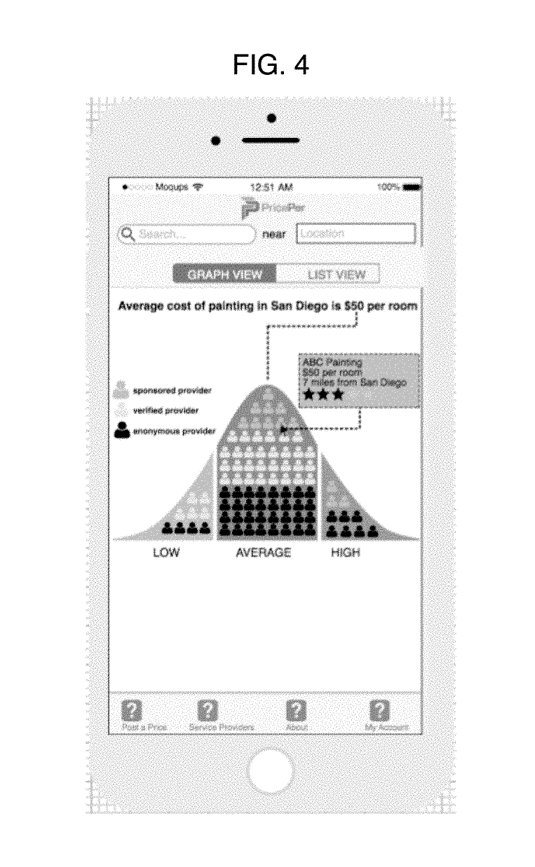

In another embodiment of the present disclosure and with reference to FIG. 4, the system is displaying each icon as a color code and displayed as a symbol that correlates to the type of provider who entered the price paid for a particular service. For example a sponsored provider is a green symbol, a verified provider is a yellow symbol and an anonymous provider is a black symbol. In an embodiment, the PricePer algorithm and method determines how many “paid” advertisers to display, in addition to the verified and anonymous prices. In an embodiment, the number of “paid” advertisers will be limited to a maximum of 5% of the total number of data points displayed. In an embodiment, a user is hovering or tapping over an icon and seeing a pop up screen with limited details on the particular icon that represents a data point that has been generated by the system. The user is able to click into the icon to view further details and navigate through to other pages in the app from this service graph page and the details page after clicking into an icon.

In another embodiment of the present disclosure, the system provides a default view based on the users selections and preferences during the registration process. In an embodiment, the user can filter the view of the service price graph to suit their particular needs, for example, can filter by conversion unit, date, deviation from average, customer reviews and a combination of more or more of these filters. In an embodiment, the user is able to adjust the view of the service price graph by dragging the graph line in all planar direction to change the filters automatically without making manual selections from a drop down box. In an embodiment, each planar direction that a user is able to drag is linked to a particular filter that is registered into the system. For example, if a user wants to see older posts, they can drag the graph line upwards from the base of the graph, communicating to the system that they want to see older postings, and the system then pulls in older data points to be plotted into the graph. If a user wants to see low prices for a particular service, they can pull the graph line in the relative direction (e.g., left) to show the lower prices or to show higher price (e.g., right). In an embodiment, the user is able to pull the service price graph into a customized curve. In an embodiment, the system has predetermined graph curves for particular filters and combinations of filters and preferences as selected by the user, such that a manual entry will result is a pre set curve for display. The curve is not limited to being a bell curve and the examples here are not limiting, for example the graph might be a straight line or combinations of straight lines, hyperbole, parabola, circle and any variations and combinations thereof.

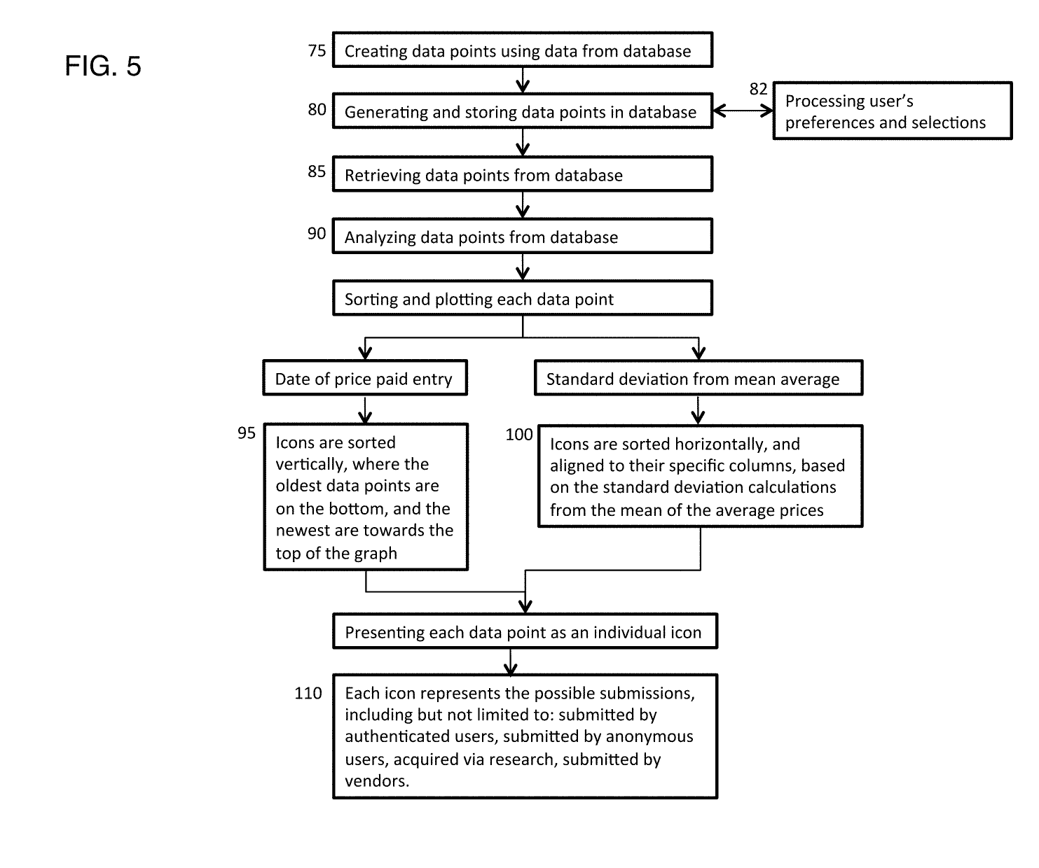

In another embodiment of the present disclosure and with reference to FIG. 5, the system uses an exemplary algorithm and method for generating the Service Price Graph. The system is generating a service price graph that a user can view and use in their decision making process for prices paid for particular goods and services.

In another embodiment of the present disclosure and with reference to FIG. 5, at step 75, the system is creating data points by using the data stored in the database, where the data is for example being collected from users about the prices paid for particular service. In an embodiment, a data point is a data packet that has multiple components, where each component can be standardized and/or customized to change the expression of the data packet during the icon generating process and the data packet can be standardized and/or customized based on the systems preferences and/or a user's preferences.

In another embodiment of the present disclosure and with reference to FIG. 5, at step 80, the system is processing and analyzing the preferences and selections made by the user during the registration process. At step 82, the system is generating and storing data points and storing the data points in a local or external server/cloud that correlates to a users preferences and selection.

In another embodiment of the present disclosure and with reference to FIG. 5, at step 85, the system is retrieving data points from the database and/or some external data source. In an embodiment, the system is retrieving selected data points based on the preferences selected by the user through a filtering and/or preference determining system.

In another embodiment of the present disclosure and with reference to FIG. 5, at step 90, a processor in the system is analyzing each data point and sorting based on predetermined parameters, such as date of entry when the price was paid, standard deviation calculations from the mean of the average prices.

In another embodiment of the present disclosure and with reference to FIG. 5, at step 95, the data and data points are being sorted based on the date of entry of the price paid, where the oldest data points are plotted toward the bottom of the graph, and the newest are plotted toward the top of the graph. The system is presenting the data point icons and sorting the icons along a vertical axis of the graph based on date of entry to indicate timing relevance of each data point. In an embodiment, a user can filter the icons by date so that the graph is displaying a selected date range of prices.

In another embodiment of the present disclosure and with reference to FIG. 5, at step 100, the system is sorting the data, creating data points and creating icons based on the standard deviation calculations from the mean of the average prices and data points are plotted horizontally across the graph and aligned into their specific columns based on the calculated deviation. In an embodiment, a user can choose to view certain sections of the deviation for example high-end prices, or low-end prices.

In another embodiment of the present disclosure and with reference to FIG. 5, at step 105, a user selecting other parameters and the system is layering the parameters onto the service price graph to create a perspective of the prices paid according to the user's desires. For example, the user can add service review layers, and choose a certain rating to display so that the system will display icons for example is a particular date range, within price deviation and high customer ratings. In an embodiment, other layers are added so that the user can achieve a particular perspective of the icons presented.

In another embodiment of the present disclosure and with reference to FIG. 5, at step 110, the system is labeling and transforming each data point into an icon or symbol that can be color coded to represent the type of provider who submitted the price data. Each icon represents the possible submissions, including but not limited to: submitted by authenticated users, submitted by anonymous users, acquired via research, and submitted by vendors. In an embodiment, the data points are plotted below the line of a standard bell curve or some other curve.

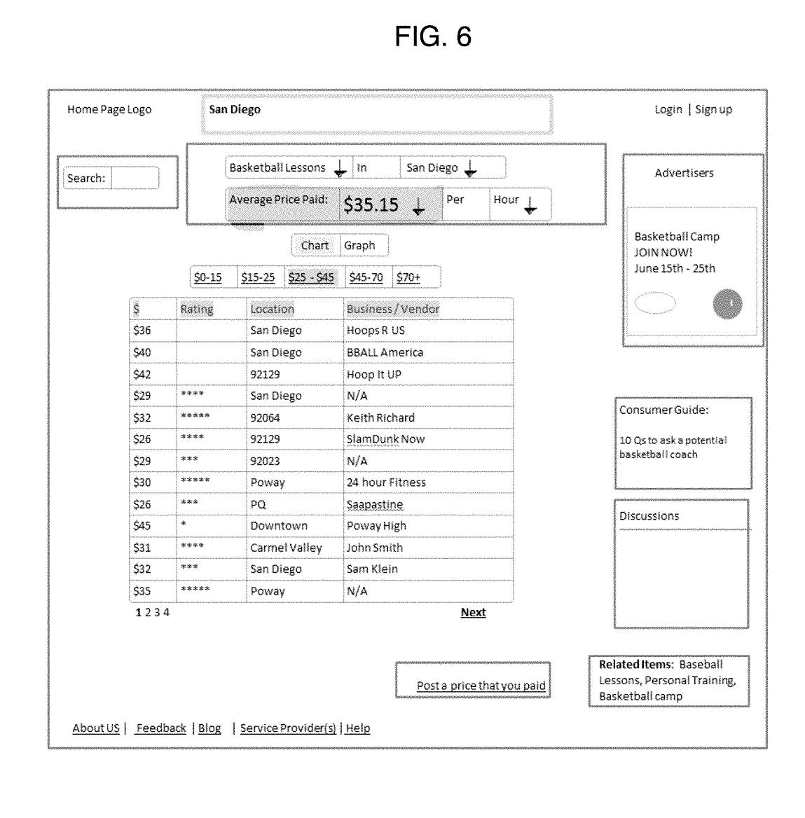

In another embodiment of the present disclosure and with reference to FIG. 6, the system allows the user to click on the average item displayed and the system directs them to a service averages page that displays a detailed list of prices paid to business providers in particular geographic areas in relation to a category of service. The system may display the same data and analysis as the Service Price Graph page, but in chart or list form. The intent of this is to make the data “flatter” and potentially easier to see. Entries are color-coded based on entry type (user, service provider, anonymous). In an embodiment, the user can toggle between a chart view and a graph view of the list. Each service that was paid for has information about the amount paid, a rating for the service, location, name of business and vendor. A user can search for other categories of services on this page and can also post a price that they paid on this page. The user can select a price range bracket for a particular service. The service average price paid for the particular service being viewed is repeated on this page, with an indication of factors that may be affecting the average price. For example if the average price has gone up or down, or is changed or affected in some way, this may be indicated by an up and down arrow, or a message relating to a particular service, for example cleaning services prices are up due to shortage of workers in the area. In an embodiment, the source of these messages and/or symbols are taken from other data sources such as published articles, and news events. In particular embodiments, authenticated users are able to input information about factors that might be affecting the average price, such as a verified experience about staff shortage, out of stock experience, oversupply experience. A user is able to interact with the message to learn further about the affected price. A user is able to further click into a single paid service item in the list to view details of a single paid service. In an embodiment, a user is able to compare single services from a list or multiple lists of the same or different services by saving and comparing the services.

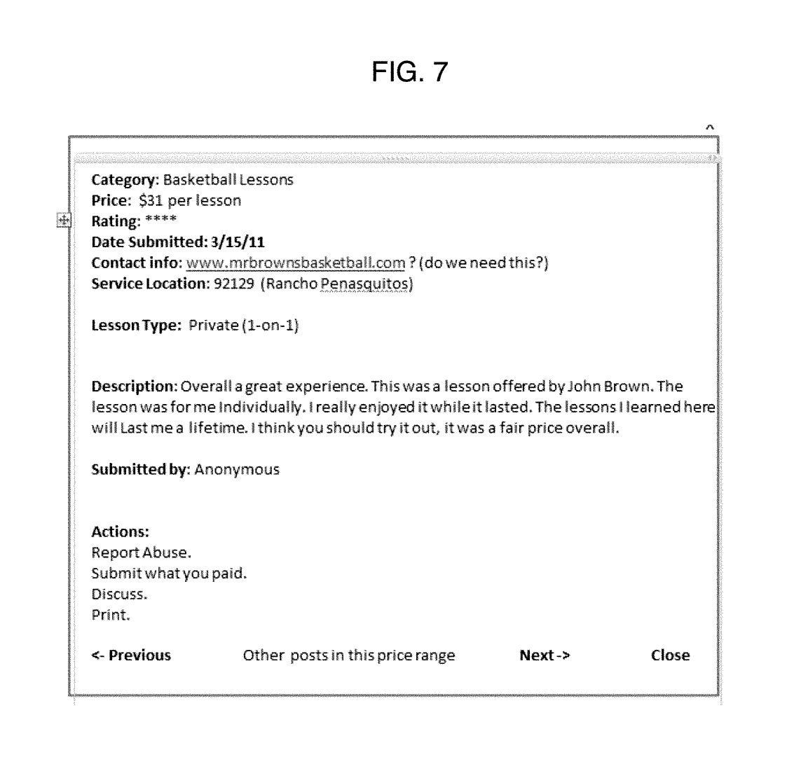

In another embodiment of the present disclosure and with reference to FIG. 7, the system displays a Detailed Service page when a user clicks on a service category item in one of the lists on the home page or other page, for viewing further details about that specific service. Its intent is to display more detailed information than can be displayed on a big graph. In an embodiment, details about the service include for example, the category, a price paid, multiple price paid, deal prices paid, offers made but not accepted, rating, date submitted, contact information for the business, location of the service, details about the service for example inclusions and exclusions, a description of the service, the user's name who submitted the details. Further actions are available to the user for example, report abuse, submit what you paid (for the user who is viewing the detailed service page), discuss, or print. A user can also view other spots in this price range for that particular service or related service. User can also select to compare the same service between multiple locations.

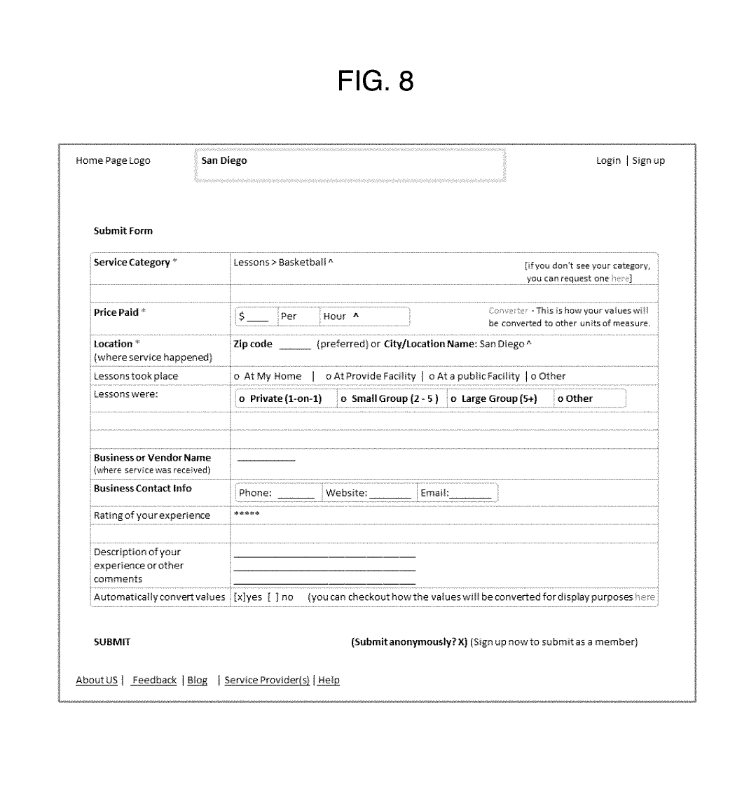

In another embodiment of the present disclosure and with reference to FIG. 8, when a user clicks on a link to post a new price that they paid for a service to be added to the database, they are able to submit the price they paid for a service via the New Service Submit page. In an embodiment, only authenticated users are able to submit this data. On this page, the user is entering details about the paid service such as Business and/or Vendor name, and a user can select a current vendor from a drop down list that appears from previously entered businesses or vendor. If a service or vendor doesn't exist, the user is able to submit a new service and/or vendor. In another embodiment, a vender or service provider may submit a new service and/or vender. When entering information about the type of service, different service-types will have different Flex-fields particular to that service type, for example a service submission in the Lessons parent category, need to capture the Location the lesson took place (at the student's home, or another location), while the Pets category would only need to know the location that the treatment took place. Another example is that when someone is submitting a “Home Improvement” category, there should be a question if the contractor is licensed. The various flex fields can later be used to sort and/or filter when viewing the information on the service graph or chart. In an embodiment, other data collected include for example, price paid per hour or unit, location of the service and option to indicate if it is mobile, business contact details and name if it is not already in the system, rating of the user's experiences, comments or description of the services received. There is a link to a converter tool for converting various measurements for example currency, time and other units of measure. Users are able to submit the service details anonymously, and are given the option to sign up to post as member. The type of user who submits the form is reflected on the service price graph and chart to create representative view of the type of information that another user is viewing.

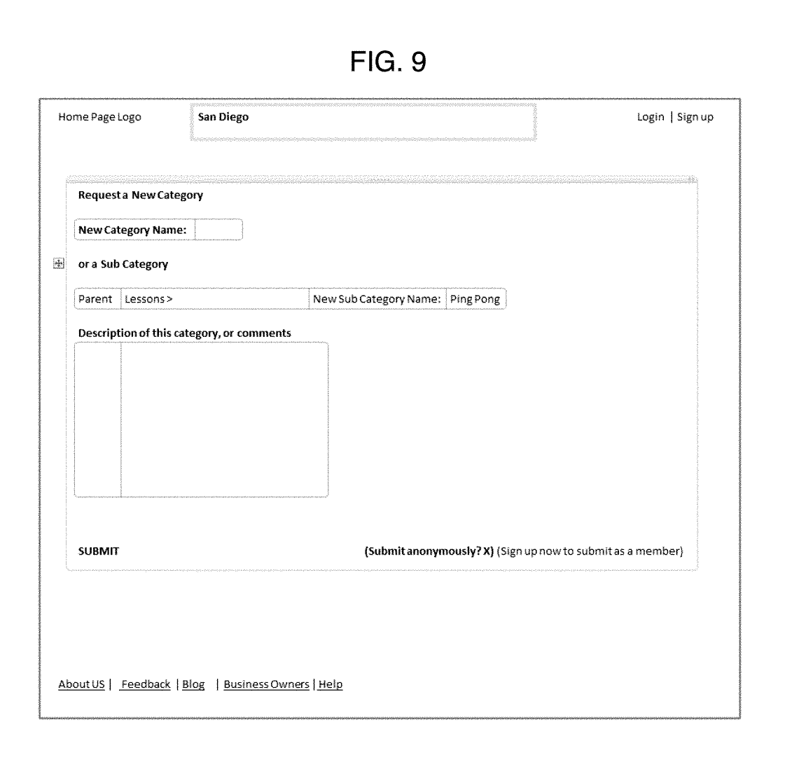

In another embodiment of the present disclosure and with reference to FIG. 9, a user is requesting to add information about a new category and/or service via the Category Request Page. When a user attempts to post a new service price paid and their service category doesn't exist there is a further link that allows the user to request a new category that is not available. At the category request page a user is inputting information such as a location, new category name, a new sub category name, choosing a related category, description about the category. Users who are Administrators are notified when new submissions arrive and process the request based on what already exists in the database and decide whether or not the newly requested category should be added.

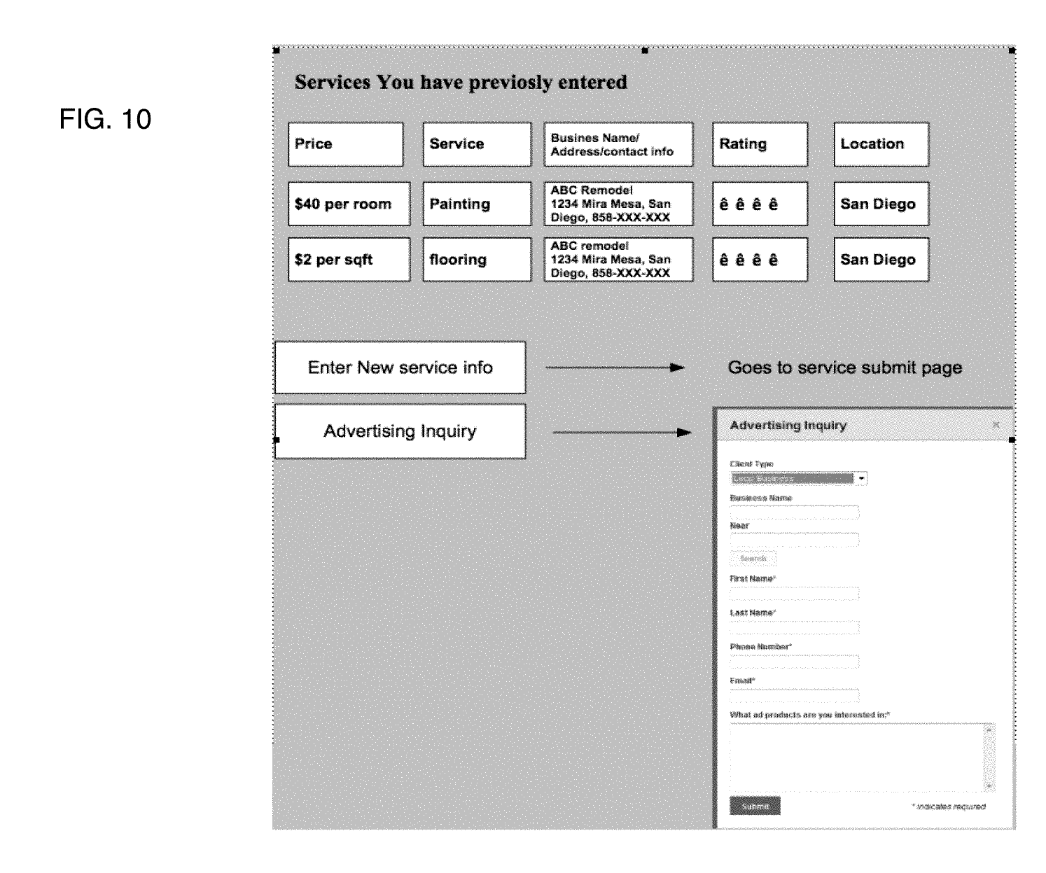

In another embodiment of the present disclosure and with reference to FIG. 10, a user who is a registered business and/or vendor is entering information about their services at the Business User page. When a user is entering the Business and/or Vendor name, the field detects existing vendors and the business contact info is pre-filled. If the Business and/or Vendor name is not located, the user is able to fill out the business contact info. This page also displays services that have been previously entered by that user. The page also allows for a user to submit an advertising inquiry with details about the intended advertisement such as client type, Business name, location, full name, contact details, and the type of advertising they are inquiring about. If the user wants to submit information for a new service, they are directed to the service submit page.

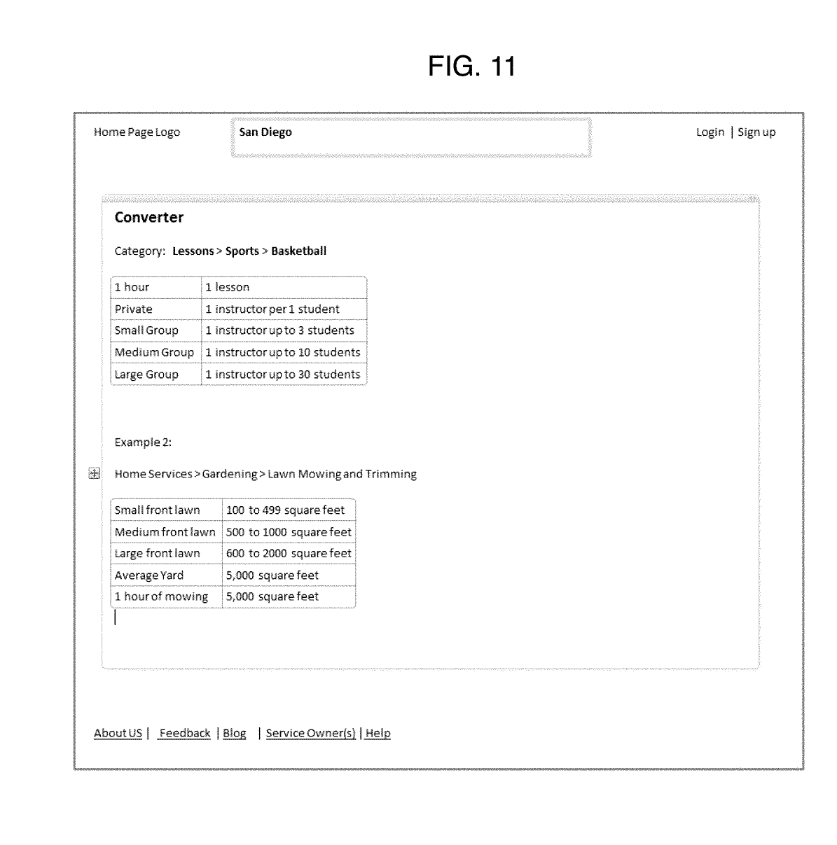

In another embodiment of the present disclosure and with reference to FIG. 11, when a user is posting a price that they paid for a service via the Service Submit Page, a user is converting the service that they paid into a basic and or common unit-of-measure via the Converter Page. In an embodiment automatic conversion takes place to reflect a basic unit-of-measure. For example if someone submits the price as “$10 per Lesson,” the converter should make it clear that one lesson lasts one hour. Tables of conversions are located on the database that allows a new posting to reflect a unit of measure for example, for a lawn mowing service, units can include small front lawn=100-499 square feet, medium front lawn=500-1000 square feet, large front lawn=600-2000 square feet, average yard=5000 square feet, one hour of mowing=5000 square feet. In other categories, customized unit converters are created specific to a particular service that can include qualitative and quantitative conversions. In an embodiment, the conversion units can be used as an extra layer of filtering when the user is searching for a price and can be integrated into the graphical display in choosing which icons to display.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein.

I claim:

1. A non-transitory, computer-readable product for providing analytics, comprising code executable by one or more processors for causing the one or more processors to
a. receive, from a first client, a data set relating to an object;
b. correlate the data set to the object;
c. cause the storage of the data set within memory;
d. enrich pre-existing static data with the data set;
e. receive, from a second client, a query that indicates an analytic function to be performed on the static data; and
f. in response to receipt of the query that indicates the analytic function to be performed on the static data
i. cause the loading of memory, from a first source, with data stored as the static data;
ii. cause real-time data to be received, as it is being generated by a second source, and to
iii. cause the return, to the second client, a result relating to the query.

2. The non-transitory, computer-readable product of claim 1, wherein the result comprises averages, modes, medians, means, variances, or standard deviations.

3. The non-transitory, computer-readable product of claim 1, wherein the object comprises goods or services purchased by the first client; or goods or services offered by sellers.

4. The non-transitory, computer-readable product of claim 1, wherein the one or more processors are further configured to
a. receive a request relating to the data set; and
b. return the data set relating to the request.

5. The non-transitory, computer-readable product of claim 1, wherein the one or more processers are further configured to
a. cause the storage of the result of the analytic function in storage media as an analytic cube for use in subsequent queries together with a time stamp in association with the result of the analytic function, as part of the analytic cube; and
b. in response to a subsequent analytic function that includes the time stamp, re-use the result of the analytic function from storage media based on the time stamp associated therewith, as a source of data for the subsequent analytic function.

6. The non-transitory, computer-readable product of claim 1, wherein the first source is external to the processor.

7. The non-transitory, computer-readable product of claim 1, wherein the second source is external to the processor.

8. A method for providing analytics comprising
a. receiving and storing a user profile;
b. sending the user profile to one or more databases over one or more wired or wireless networks;
c. receiving input from a user relating to an object, the object being a good or a service;
d. sending the input from the user to the one or more databases to be used to enrich the object;
e. receiving a request for analytics from the user;
f. sending the request to the one or more databases;
g. receiving a response to the request from the one or more databases; and
h. displaying the response to the user.

9. The method of claim 8, wherein the object comprises a good or a service purchased by the user or a good or a service offered to the user.

10. The method of claim 8, wherein the response comprises averages, modes, medians, means, variances, or standard deviations.

11. The method of claim 8, wherein the response comprises
a. an aggregate of data from sources other than the user; and
b. a particular data set specified by the user.

12. A system for providing analytics comprising;
a. one or more storage devices; and
b. a plurality of processors, the plurality of processors being configured to
i. receive, from a first client, a data set relating to an object;
ii. correlate the data set to the object;
iii. store the data set within the one or more storage devices;
iv. enrich pre-existing static data with the data set;
v. receive, from a second client, a query that indicates an analytic function to be performed on the static data; and
vi. in response to receipt of the query that indicates the analytic function to be performed on the static data, cause the
1. loading of the data stored on the one or more storage devices as the static data;
2. receipt of real-time data by the processor as it is being generated by a second source; and
3. return of a result, relating to the query, to the second client.

13. The system for providing analytics as recited in claim 12, wherein the plurality of processors is operable in conjunction with a non-transitory, computer-readable product comprising code executable by a processor.

14. The system for providing analytics as recited in claim 12, wherein the result comprises averages, modes, medians, means, variances, or standard deviations.

15. The system for providing analytics as recited in claim 12, wherein the object comprises goods or services purchased by the first client; or goods or services offered by sellers.

16. The system for providing analytics as recited in claim 12, wherein the plurality of processors is further configured to
a. receive a request relating to the data set; and
b. return the data set relating to the request.

17. The system for providing analytics as recited in claim 12, wherein the plurality of processers is further configured to
a. cause the storage of the result of the analytic function in storage media as an analytic cube for use in subsequent queries together with a time stamp in association with the result of the analytic function, as part of the analytic cube; and
b. in response to a subsequent analytic function that includes the time stamp, re-use the result of the analytic function from storage media based on the time stamp associated therewith, as a source of data for the subsequent analytic function.
